(19) United States
(12) Patent Application Publication
(10) Pub. No.: US 2008/0263024 A1
(43) Pub. Date: Oct. 23, 2008

(54) ELECTRONIC DEVICE WITH A RANKING OF APPLICATIONS BASED ON LOCATION AND METHOD OF USING THE SAME

(75) Inventors: Assaf Landschaft, Muenchen (DE); Shajith Chaco Thengummootil, Bangalore (IN)

Correspondence Address: HITT GAINES, PC;LSI Corporation, PO BOX 832570, RICHARDSON, TX, 75083, US

(73) Assignee: Agere Systems, Inc., Allentown, PA (US)

(21) Appl. No.: 11/737,877

(22) Filed: Apr. 20, 2007

(51) Int. Cl. G06F 17/30

(52) U.S. Cl. 707/5

(57) ABSTRACT

The present invention provides for a portable electronics device and a method of using the same. In one embodiment, the portable electronics device is comprised of (1) a position locator for determining an approximate location of the device; (2) an application correlator for correlating the approximate location with an application; and (3) a ranking generator for ranking the application relative to the approximate location.

### TECHNICAL FIELD OF THE INVENTION

The present invention is directed, in general, to a portable electronic device, more particularly, to a portable electronic device where available software applications are ranked based on an associated location or position and a method of using the same.

### BACKGROUND OF THE INVENTION

Portable electronic devices, such as laptop computers, cellphones, PDAs, MDAs and so on, are typically provisioned with a number of different applications. Cell phones, MDAs and PDAs frequently include e-mail, media file players and web browsers, as well as other more traditional applications. In many cases, the number of available applications is large and growing.

When a number of applications are available to a user, he or she will generally develop a pattern of when particular applications are accessed. In many cases, the usage pattern is based on where the user is located when he or she opens a particular application. For example, on weekdays before going to work, the user may always review his or her appointment schedule. When the user arrives at work, he or she may open an e-mail application to respond to incoming messages. While working out at the gym, he or she may want to listen to music and will open a media file player to access such music. While commuting home in the evening, the user may access the Internet to check the nightly television schedule or catch up on the news.

Currently, portable electronic devices present a user a list of applications from which he or she is to select an application to be opened. The user interface generally shows a static application list independent of the user's location. The user must navigate through the same menus and options each time an application is to be accessed. As portable electronic device manufacturers cram more and more technologies into their devices, the number of actions required to navigate through a menu and the corresponding sub-menus continues to increase. The effort required to access a specific application can become quite time consuming as well as complex. There is some risk that manufacturers will alienate users who simply want to use their portable electronic device for only a few applications. By pushing too far in adding applications, “feature bloat” may become overwhelming, intensifying usability problems.

Accordingly, what is needed in the art is a device and method whereby a user of a mobile electronic device, such as a mobile communications device, can more readily access desired applications based on his or her location.

### SUMMARY OF THE INVENTION

To address the above-discussed deficiencies of the prior art, the present invention provides, in one aspect, a portable electronics device comprised of (1) a position locator for determining an approximate location of the device; (2) an application correlator for correlating the approximate location with an application; and (3) a ranking generator for ranking the application relative to the approximate location.

The present invention thus provides a device and method for ranking available applications based on the relative location of the device when an application is to be selected. The present invention provides for the user to be presented with a menu of application choices most relevant to his or her location. For example, a user in his or her business office will be offered a menu of application choices consistent with that location. On the other hand, when the user is at home, the menu of applications from which a choice can be made will be quite different and consist of applications most often selected at that location. An additional benefit of the invention provides for available applications to be ranked. Ranking will generally be based on frequency of usage at a particular location, although user input and other criteria can also be used to rank applications. For example, if a user opens a word processing application on his or her laptop computer more frequently than a spreadsheet program while at his or her place of business, the present invention will rank the word processing application higher than the spreadsheet application. However, one embodiment of the invention permits the user to input a ranking that ranks the spreadsheet application higher than the word processing program, if he or he so elects.

As used herein the term “application” or “applications” means any type of application generally provisioned on a portable or mobile electronic device utilizing hardware or software to run the application. Applications include, without being limited to, office software, word processors, e-mail applications, media file players and web browsers. As used herein, portable electronic devices include all types of devices capable of running any such application, including, without limitation, portable computers of all types, mobile communication devices, gaming devices and so forth.

In one embodiment of the invention, the position locator is a GPS or is based on GPS technology. In another embodiment, the position locator determines the approximate location of the portable electronic device based on at least one communication cell identifier within a communication network.

A particularly useful embodiment of the invention provides for the user to rate a selected application for the ranking generator. Even if a user utilizes a word processing application more often than an e-mail application, he or she can rank the e-mail application higher than the word processing application, if he or she so desires.

One embodiment of the invention provides for the approximate location of the device to be a geographic location. In another embodiment, the approximate location is based on a zone. Such zone may, for example, be a business center rated by the user as being a location where business applications are prioritized.

In another embodiment of the invention, the ranking generator ranks applications by monitoring a usage pattern. Another embodiment provides for the usage pattern to be based on an approximate location when an application is accessed, the number of times an application is accessed and the duration of each such access. Thus, the portable electronic device will offer a menu of applications from which a selection can be made based on the user's history of application usage. Further sophistication related to the ranking of applications is available in an embodiment wherein the ranking generator includes a time or a date, or both a time and a date, when an application is accessed. Thus, if an application is only accessed on weekends, such application will be ranked higher on a weekend than it would be on a weekday. If a music program is accessed less frequently than an email program, but the duration of access is longer, the music program can be ranked higher than the email program.

A useful embodiment of the invention provides for the ranking of applications to be automatically updated. Another embodiment provides for the ranking generator to further define at least one zone as the approximate location so that whenever the device is in that zone, the ranking of applications will be the same throughout the zone. A user can also define more than one zone and require the device to provide a similar ranking to applications in similar zones.

An embodiment of the invention provides for the portable electronic device to display the ranking of applications on a user interface. In yet still another embodiment, the user interface displays a set of shortcuts.

In one embodiment of the invention, the portable electronic device is selected from the group consisting of a portable computer; a mobile phone; a PDA; an MDA; a Pocket PC; or a Tablet PC. The invention also provides several embodiments of a method of using a portable electronic device, which embodiments will be understood by a person skilled in the pertinent art based on the disclosure set forth herein.

The foregoing has outlined preferred and alternative features of the present invention so that those skilled in the pertinent art may better understand the detailed description of the invention that follows. Additional features of the invention will be described hereinafter that form the subject of the claims of the invention. Those skilled in the pertinent art should appreciate that they can readily use the disclosed conception and specific embodiment as a basis for designing or modifying other structures for carrying out the same purposes of the present invention. Those skilled in the pertinent art should also realize that such equivalent constructions do not depart from the spirit and scope of the invention.

### BRIEF DESCRIPTION OF THE DRAWINGS

For a more complete understanding of the invention, reference is now made to the following descriptions taken in conjunction with the accompanying drawings, in which: FIG. 1

FIG. 1 illustrates is block diagram of a portable electronic device constructed in accordance with the present invention;

FIG. 2 illustrates a diagram of a telecommunications network in which a mobile phone utilizes a position locator to determine an approximate location;

FIG. 3 illustrates an embodiment of the present invention employing the global positioning system as a position locator;

FIG. 4 illustrates a flow chart showing an embodiment of the present invention establishing a relationship between an application and a location;

FIG. 5 illustrates a flow chart showing an embodiment of the invention displaying mobile phone applications on the basis of a location dependent ranking where a relationship of applications to locations has been previously established;

FIGS. 6A and 6B illustrate are tables showing a ranking schedule of applications constructed in accordance with an embodiment of the present invention; and

FIGS. 7A and 7B illustrate a planar frontal view of a mobile phone displaying icons and shortcuts of preferred applications for a specific location that are ranked and listed by using an embodiment of the present invention.

### DETAILED DESCRIPTION

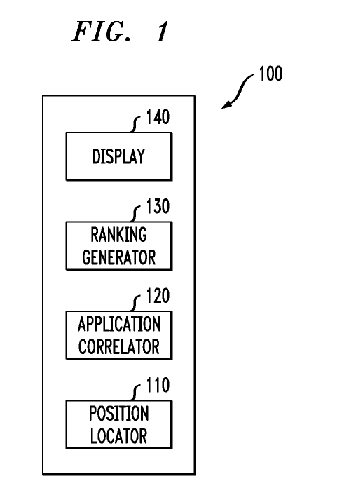

Referring initially to FIG. 1, illustrated is block diagram of a portable electronic device 100 constructed in accordance with the present invention. The portable electronics device 100 has a position locator 110 that determines the approximate location of the device when a user is selecting an application to run on the device. Most times and in one embodiment of the invention, the location is a geographic location. An application correlator 120 correlates applications with the approximate location of the device. A ranking generator 130 ranks the available applications relative to the approximate location.

Based on the approximate location of the device 100, a user of the device 100 is presented a menu of applications most relevant to his or her location. In one embodiment this menu is presented on an interface 140 on the device 100, which may be a display. In another embodiment of the invention, the interface 140 presents a list of shortcuts to the applications. For example, if a user is in his or her business office when an application is to be selected, the application correlator 120 will correlate that location to the available applications, the applications will be ranked, and the user will be offered a menu of application choices from which to make a selection. If the user is at his or her home when an application is to be selected, the menu of applications offered will differ from that presented at the office.

In ranking applications, the ranking generator 130 will generally base its ranking on frequency of usage of a particular application at a particular location. However, the invention also permits user input and other criteria to be a factor in the ranking. For example, if a user at his or her place of business opens a word processing application on his or her laptop computer more frequently than a spreadsheet program, the present invention provides for the ranking generator to prioritize the work processing application over the spreadsheet application. However, if the user opens the spreadsheet application once each day and leaves it open all day because he or she is entering data all day and the word processing application is opened a number of times during the day solely to respond to correspondence, the user may want the spreadsheet application ranked higher than the work processing application because of its importance. Thus, in one embodiment of the invention the user can input criteria by which the ranking generator prioritizes applications and thereby choose to make the spreadsheet application rank higher than the word processing application.

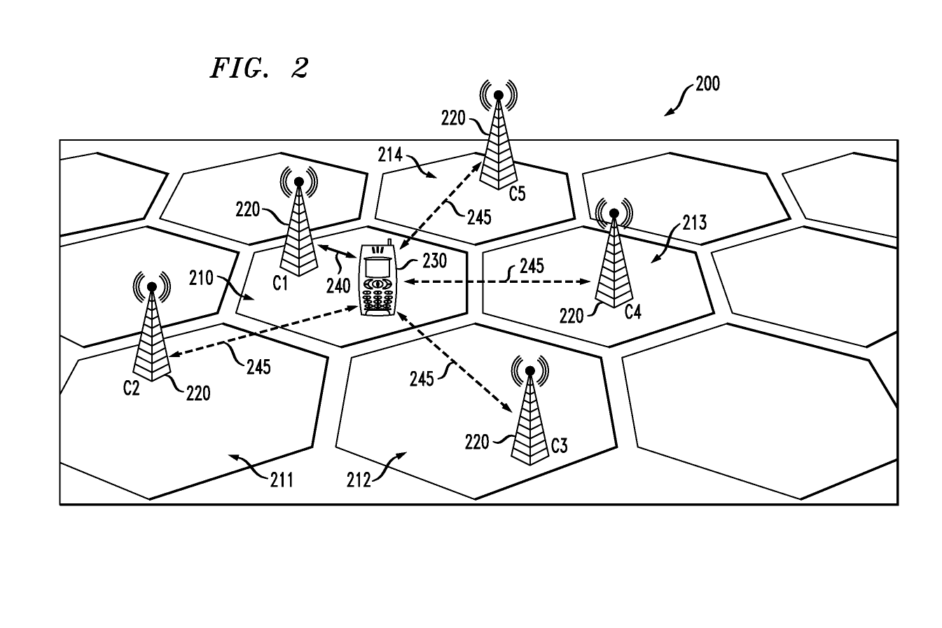

Turning now to FIG. 2, illustrated is a diagram of a telecommunications network 200 in which a mobile phone 230 utilizes a position locator 110 to determine an approximate location. The communications network 200 is divided into cells 210-214, each of which has an antenna 220 or base station to provide connectivity. This telecommunications network 200 may be operated in accordance with GSM or UMTS standards.

The position locator 110 determines the approximate location of the illustrated mobile phone 230 by its position 240 relative to the antenna 220 located in cell 210. Although a number of different techniques may be used for the position locator to determine the approximate location of the mobile phone 230, one technique is to utilize a look-up table programmed in the mobile phone's 230 memory that maps cell 110-114 identifiers to geographic locations. Utilizing this information, the position locator 110 determines that the approximate geographic location of the mobile phone 230 is in cell 210. The look-up table can be automatically and dynamically updated as the network 200 cell 210-214 structure changes or is modified. Because the mobile phone 230 also receives signals 245 from antennas 220 or base stations located in adjacent or nearby cells 211-214, the signal information from these cells 211-214 can also be used to determine or calculate a more precise location of the mobile phone 230. Signal processing techniques, such as signal amplitude analysis, can be used to make this calculation.

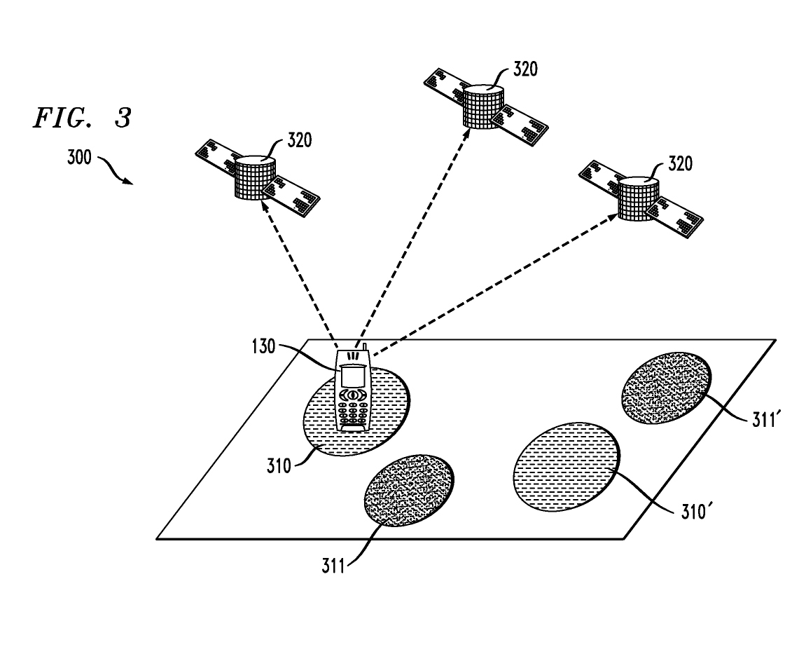

Turning now to FIG. 3, illustrated is an embodiment of the present invention employing the global positioning system (GPS) 300 as a position locator 110. Also shown is the use of the GPS 300 to define regions or zones 310, 311. Although GPS is illustrated, any system whereby an approximate location can be determined can be used. Such systems may include, without being limited to, GLONASS, GALILEO, TACAN, VOR, LORAN and so forth and still be within the intended scope of the present invention.

Zones 310 and 310′ are shown as having characteristics similar to each other as are zones 311 and 311′. Zone 310 may be a first business center and zone 310′ a second business center, each of which is entered into the memory of a portable electronic device 100 as a business center. A mobile phone 130 is shown as being located in zone 310, the first business center 310, which position is determined by the position locator 110 utilizing information derived from GPS satellites 320. Because zone 310 is already defined as a business center in the mobile phone 130 memory, the application correlator 120 will correlate the position to business center related applications. The ranking generator 130 will then rank and present those applications to the user. One embodiment of the invention provides that a ranking can be established for a first zone 310, 311 and such ranking can then be applied to all similar zones 310′, 311′ having similar characteristics. For example, if a ranking is applied to a church, the same ranking can be applied to all churches. Actually in such case, the desired result may be to prohibit certain applications in certain locations, which prohibition corresponds to a kind of ranking. One embodiment of the invention provides for the user to provide the ranking by manually selecting or inputting the ranking.

In one embodiment of the invention, the size or dimension of the zones 310, 311 can be defined by user input or by using substantially constant regional characteristics. For example, assume zones 311 and 311′ are residential areas, which are not usually considered to be business centers. However, if the user is a residential real estate agent, these zones 311, 311′ will be considered business zones. The present invention permits a user to control the ranking of applications.

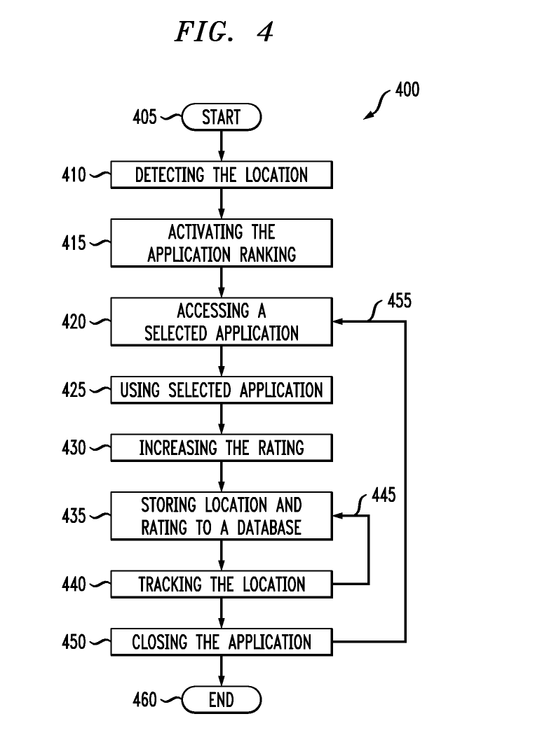

Turning now to FIG. 4, illustrated is a flow chart 400 showing an embodiment of the present invention establishing a relationship between an application and a location. Commencing with a start step 405, a position locator determines the approximate location of the portable electronic device, assumed to be a mobile phone, in a detecting the location step 410. Once the approximate location of the mobile phone is known, the application correlator can relate available applications to the location, assuming a relationship of applications to locations has been previously established. Based on this correlation, the ranking generator is activated in a activating the application ranking step 415 and applications are ranked. The user can then access an application in an accessing a selected application step 420. In one embodiment, the user can use a common application shortcut menu to access an application. The selected application is then used in using selected application step 425. By using the selected application, the ranking or rating of the selected application is increased in an increasing the rating step 430. The increased ranking and geographic location of the mobile phone are stored in a storing location and rating to a database step 435. Such database may, for example, consist of a look-up table with a counter that maps the frequency of access to a particular application as well as the user's location each time the application is accessed.

To keep a correct relationship record between the mobile phone location and applications accessed, one embodiment of the invention provides for the location of the mobile phone to be tracked in a tracking the location step 440. This serves to keep the actual location of the mobile phone, or relevant portable electronic device, in correct relationship to a selected application. If the user's position is changing from one cell to another while a particular application is in use, the position as it changes is tracked in a tracking the location step 440. To keep track of such a change, in a loop back 445, the position and ranking are stored in the device's memory and the storing location and rating to a database step 435 are repeated. This loop back 445 can be repeated as frequently as necessary. After a user terminates an application in a closing the application 450 step, in a second loop back 455 the user can select another application by repeating the accessing the selected application step 420. If the user does not want to select another application after the closing the application step 450, the procedure is ended in an end step 460.

In one embodiment of the invention, the only location stored in the device memory, in the storing location and rating to a database step 435, is the location of the device when the application is selected initially. This embodiment may not include a tracking the location step 440.

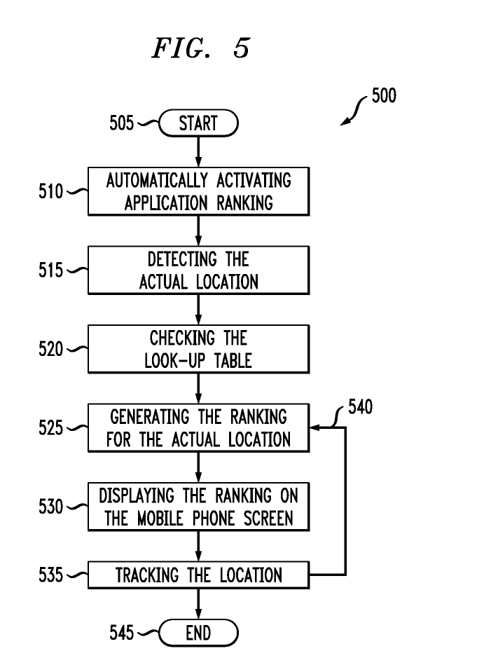

Turning now to FIG. 5, illustrated is a flow chart 500 showing an embodiment of the invention displaying mobile phone applications on the basis of a location dependent ranking where a relationship of applications to locations has been previously established. The procedure commences with a start step 505. The ranking of applications by the ranking generator is activated automatically in an automatically activating application ranking step 510. In most cases, a user will probably set the mobile phone to utilize this as a standard setting. In a detecting actual location step 515 a position of the mobile phone is detected and determined by the position locator in the manner previously described. This is done in the instant case by utilizing a look-up table in the memory of the mobile phone in a checking look-up table step 520. The application correlator then correlates available applications with the location and the ranking generator generates a ranking of applications in a generating the ranking for the actual location step 525. The resulting ranking will then be displayed to the user in a displaying ranking on mobile phone screen step 530. To keep the relationship between the location of the mobile phone and the application, the mobile phone location is tracked in a tracking the location step 535. As the user's location varies while a particular application is open, the system can loop back 540 and repeat the generating ranking for actual location step 525. The application ranking will continue to be updated based on the actual location of the mobile phone. The application closes with an end step 545.

In one embodiment of the invention the generating the ranking for the actual location 525 step can also include a feature that corresponds to a ranking for a location having particular characteristics. For example, referring back to FIG. 3, zones 310 and 310′ have similar characteristics. They can each be assigned a ranking based on such common characteristics. If an application is accessed in zone 310, the first business center, the same ranking can be used when the user is in zone 310′, the second business center. Thus, if a portable electronic device has a memory that includes a lookup table that maps cell-IDs and their characteristics, applications in different zones having similar characteristics can be ranked before a particular zone is even visited.

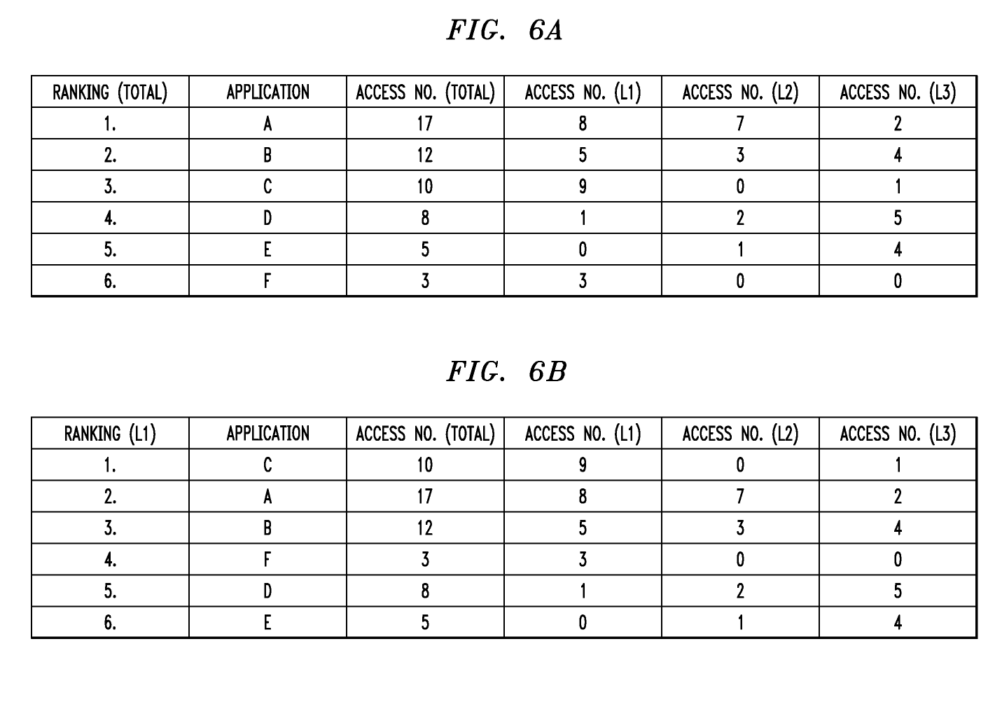

Turning now to FIG. 6A, illustrated is a table showing a ranking schedule of applications as they may be constructed with the present invention. The ranking of applications can be generated in accordance with the sequence of actions described with respect to FIG. 4. Stored in the mobile communication device's memory is a record of both the number of times a particular application is accessed as well as the geographic location when accessed. The illustrated table shows a ranking made up of the total number of times a particular application was accessed and the number of times each application was accessed at a specific location, designated as L1, L2 and L3 for illustrative purposes.

Turning now to FIG. 6B illustrated is a ranking schedule with respect to location L1 of applications accessed utilizing the sequence of actions illustrated with respect to FIG. 5. The location where an application is selected is detected and ranked in accordance with the number of times such application is accessed at that location. Thus, because application C has been accessed most often in location L1, application C is now placed in the number one position of the ranking for L1. This means that it will be the first application or application shortcut displayed in a sequence when the portable electronic device is in location L1.

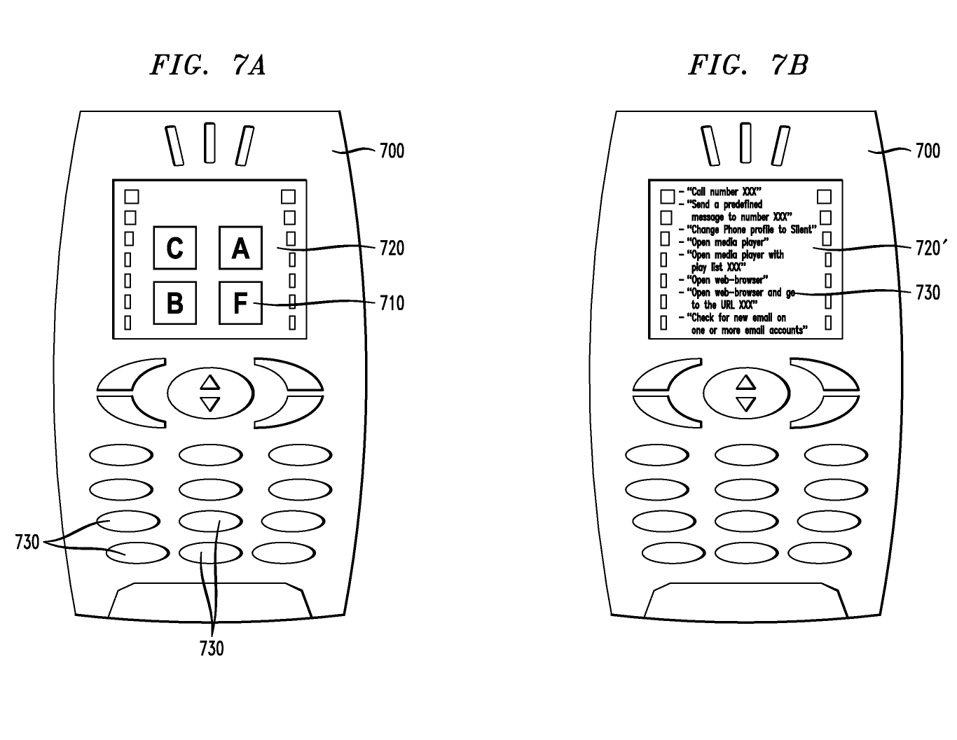

Turning now to FIGS. 7A and 7B, illustrated are planar frontal views of a mobile phone 700 displaying icons 710 of preferred applications on its screen 720 based on its being located in a specific location. Although a mobile phone 700 is illustrated, one embodiment of the invention provides that the portable electronic device, as such term is used throughout this application, can be selected from the group consisting of a portable computer; a mobile phone; a PDA; an MDA; a Pocket PC; or a Tablet PC. The illustrated icons 710 are those set forth in FIG. 6B as most frequently accessed. The screen 720′ in FIG. 7B presents a text menu 730 relating to the geographic location of the mobile phone 700. The illustrated screen 720 in FIG. 7A only has room for four application icons 710 to be displayed. The four icons 710 displayed are the first four listed in the ranking at location L1 in FIG. 6B, which are C, A, B and F. These application icons 710 correspond to shortcuts to the relevant application. In one embodiment of the invention, the relevant application can be accessed by a user pressing a key 730 that corresponds to the icon 710 representing the desired application. Control can also be combined with a function key. In another embodiment of the invention, the icons 710 can be selected by utilizing a touch screen and the application accessed directly. For example, if a user listens to music while walking in the park, a media file player or its shortcut will be shown as one of the icons 710 on the user interface when the user is in the park. When the user wants to access this application, this icon 710 would most probably be ranked near or at the top of the list of applications offered. This permits the user to select the desired application with a minimum of effort and time expended.

FIG. 7B shows a user interface feature that consists of a set of shortcuts. These shortcuts are presented in an easily accessible fashion, either on the main screen 720′ or on a shortcut menu corresponding to actions the user can perform. Examples of such shortcuts are set forth as a list from which a user can make a selection. These shortcuts are presented to the user based on the data regarding earlier selected applications and the geographic location of the mobile phone 700 when the applications were selected. The user sees applications or actions that he or she most frequently performed in the applicable location. The applications or shortcuts most frequently selected are ranked the highest.

Collected data regarding each application can include, in addition to the application selected, information about what was done in the application. For example, if a web browser was used, data regarding the web-site viewed, the location at which that web-site was viewed, the time of day the web-site was viewed, as well as other available information can be recorded and stored to be used in a subsequent ranking of applications.

Thus, the present invention provides an enhanced application service for portable electronic devices, in particular mobile communication devices, whereby a user is presented a list of applications customized to the location of the device. The present invention also includes several embodiments of methods of ranking applications based on the position of the portable electronic device. These methods will be readily apparent to those skilled in the pertinent art based on the disclosure herein set forth.

Although the present invention has been described in detail, those skilled in the pertinent art should understand that they can make various changes, substitutions and alterations herein without departing from the spirit and scope of the invention in its broadest form.

What is claimed is:

1. A portable electronic device, comprising:
a position locator for determining an approximate location of said device;
an application correlator for correlating said approximate location with an application; and
a ranking generator for ranking said application relative to said approximate location.

2. The device as recited in claim 1 wherein said position locator is a GPS.

3. The device as recited in claim 1 wherein said position locator determines said approximate location based on at least one communication cell identifier within a communication network.

4. The device as recited in claim 1 wherein said ranking generator permits a user to rate said application.

5. The device as recited in claim 1 wherein said approximate location is a geographic location.

6. The device as recited in claim 1 wherein said ranking generator determines said rank by monitoring a usage pattern.

7. The device as recited in claim 6 wherein said usage pattern is based on said approximate location when said application was accessed, the number of times said application was accessed and the duration of each such access.

8. The device as recited in claim 1 wherein said ranking generator further includes a time or a date or both a time and a date said application was accessed.

9. The device as recited in claim 1 wherein said ranking is automatically updated.

10. The device as recited in claim 1 wherein said ranking generator further includes defining at least one zone as said approximate location.

11. The device as recited in claim 1 further including a display for displaying said ranking on a user interface.

12. The device as recited in claim 11 wherein said user interface displays a set of shortcuts.

13. The device as recited in claim 1 wherein said portable electronic device is selected from the group consisting of:
a portable computer;
a mobile phone;
a PDA;
an MDA;
a Pocket PC; or
a Tablet PC.

14. A method of ranking a portable electronic device application, comprising:
using a position locator to determine an approximate location of said device;
causing an application correlator to correlate said approximate location with an application; and
using a ranking generator to rank said application relative to said approximate location.

15. The method as recited in claim 14 wherein said position locator is a GPS.

16. The method as recited in claim 14 wherein said position locator determines said approximate location based on at least one communication cell identifier within a communication network.

17. The method as recited in claim 14 wherein said ranking generator permits a user to rate said application.

18. The method as recited in claim 14 wherein said approximate location is a geographic location.

19. The method as recited in claim 14 wherein said ranking generator determines said rank by monitoring a usage pattern.

20. The method as recited in claim 19 wherein said usage pattern is based on said approximate location when said application was accessed, the number of times said application was accessed and the duration of each such access.

21. The method as recited in claim 20 wherein said ranking generator further includes a time or a date or both a time and a date said application was accessed.

22. The method as recited in claim 14 wherein said ranking is automatically updated.

23. The method as recited in claim 14 wherein said ranking generator further includes defining at least one zone as said approximate location.

24. The method as recited in claim 14 further including displaying said ranking on a user interface.

25. The method as recited in claim 24 further including displaying a set of shortcuts.

26. The method as recited in claim 14 wherein said portable electronic device is selected from the group consisting of:
a portable computer;
a mobile phone;
a PDA;
an MDA;
a Pocket PC; or
a Tablet PC.
